(19) United States
(12) Patent Application Publication
(10) Pub. No.: US 2005/0248676 A1
(43) Pub. Date: Nov. 10, 2005

(54) High-speed frame transfer of sub-frame area

(76) Inventor: Mark Christenson, Oro Valley, AZ (US)

Correspondence Address: Howard R. Popper, Ste #35, 4436 E. Camelback Rd., Phoenix, AZ, 85018-2833, US

(21) Appl. No.: 10/841,693

(22) Filed: May 8, 2004

(51) Int. Cl. H04N 3/14; H04N 5/335

(52) U.S. Cl. 348/317; 348/314

(57) ABSTRACT

In accordance with the invention, a region of interest (ROI) acquired by a frame transfer CCD is read out as quickly as if the imaging area of the CCD were no larger than the ROI. The imaging area of the CCD outside of the ROI is masked, preventing light from contaminating the rest of the imaging area. After a suitable exposure time the image pixels of the ROI are shifted into the storage region of the frame transfer CCD. Once the ROI is under the mask in the storage region, the next exposure may begin, and so too does the image readout. Now the CCD shifts exactly the number of rows in the ROI into the serial register one at a time and digitizes the number of pixels in each row. This process results in a series of valid ROIs separated by a series of spacer regions pipelining down the storage region of the CCD. As an example, using a standard frame transfer mode of operation, a commercially available frame transfer camera (IPentaMAX) can achieve 83 FPS on a 50×50 ROI. In accordance with this invention, a 50×50 ROI can be read out at 877 FPS

### FIELD OF THE INVENTION

This invention relates to charge coupled devices and, more particularly, to an arrangement for high speed readout of a small area of interest in the image acquired by the charge coupled device.

### BACKGROUND OF THE INVENTION

Digital cameras utilize a charge coupled device (CCD) to convert photons into an electronic signal that can be measured. In full frame imaging, the photons are collected on discreet elements referred to as pixels and then the charges that accumulate in the pixels are read out by the camera electronics. The process of readout typically requires the collected charges to be shifted in parallel rows down the columns of the image CCD sensor into a serial register at the bottom of the CCD. While the rows of charges are being shifted into the serial register, the CCD must be shuttered to avoid blurring the image. The rows of charges entered into the serial register are shifted along to a read out amplifier that measures the charges one pixel at a time and converts each analog signal to digital value. High speed readout of a standard CCD camera is limited by the analog to digital conversion rate and by the number of CCD pixels that must be digitized. Until all of the rows of pixels have been converted to digital signals by the charge measuring read out amplifier, or have been discarded, another image cannot be acquired.

A faster form of prior art imaging, shown in FIGS. 1-4, uses a process known as frame transfer in which the CCD is divided in half, one portion 11 being exposed to light while the other portion 12 is shielded from light by a frame transfer mask (not shown) and serves as a storage area. The frame transfer mask is a light barrier that is provided either by a mask applied directly on the CCD or by a mask in the conjugate optical plane so that light is prevented from directly impacting the silicon surface where the collected image will be stored. This mask provides a clean surface or clean memory area for image storage. Once the exposed image has been shifted into the storage area, another image can be collected on the exposed area. Frame transfer is faster than full frame imaging because another image can be acquired without waiting for the analog to digital operation to be completed. This overlapped mode allows the camera to run at nearly 100% duty cycle.

In scientific applications it is often desirable to speedily record successive observations where important changes may be rapidly taking place in a small region of interest, “ROI”. Unfortunately, as shown in FIGS. 1-4, defining an ROI in the image portion of a CCD still requires that all the rows within the imaging region of the CCD are shifted into the serial register 13 in order to clear the charge that has built up on the pixels. Moreover, there is considerable overhead in shifting and readout that slows down the pace at which successive images can be acquired and digitized.

It would be ideal to have a CCD that was equivalent in size to the ROI so that one would not have to incur the overhead of processing all the pixels from a large CCD. Unfortunately, because the ROI will usually be of a different size for different observations it would not be practical to have different size CCDs to accommodate all of the possibilities. Accordingly, a standard CCD must be made to produce an ROI by mechanically or electrically masking off the rest of the CCD surface so that only the region of interest were exposed. However, even with all but a small portion of the CCD surface masked off, the speed of analog to digital conversion is still limited by the need to shift the same number of times as for an entire CCD.

Some speed improvement might theoretically be obtainable by shifting multiple “dummy” rows (those rows without useful information) into the serial register and then dumping the combined charge together as long as the accumulated charge in the serial register does not spill back into the storage region and mix with charge from the ROI. As the ROI gets smaller, however, there is a fundamental overhead incurred in pixel shifting and dumping that limits the overall speed of readout. Since the whole CCD is exposed to light all the charge on the CCD must be cleared either by readout (for the ROI) or by dumping (regions outside the ROI). The time required to do all this shifting, digitization and dumping creates a barrier to achieving higher frame rates.

The difficulty of achieving fast readout is further exacerbated when the intensity of the signal within the ROI is very low because the accumulated signal is smaller than the readout noise of the cameras electronics. To overcome this problem, the signal can be amplified by adding a charge multiplying register 15 to the end of the usual serial register 13. The extended serial register 15 multiplies the pixel charges through carrier multiplication (CCM) before the charge is to be converted into a measurable voltage. Charge gain is obtained by using a single carrier impact ionization process that occurs as the carrier travels through high field regions created between the gates of suitably designed serial register. Some of the electrons gain enough energy to generate new electrons via impact ionization and though the probability of impact ionization is low, the use of many stages provides significant gain. The net gain is approximately equal to (1+p)ⁿ where p=probability of creating a secondary event and n=number of stages. For p=2% and n=400 stages, the net gain would be about 2,700 times. The requirement that many stages be used means that the serial register will typically be much longer than that of a standard CCD serial register. The process of moving the charge through the extended serial register 15 adds to processing overhead time and further slows down the image encoding process.

### SUMMARY OF THE INVENTION

In order to achieve higher frame readout rate for a small, dimly illuminated ROI, the CCD camera is programmed to operate as if it were a mini-CCD having fewer rows and pixels so as to avoid the time overhead of shifting all of the CCD charges into the frame store area region and thereafter to serially pass all of CCD's pixels through the serial register. In accordance with the invention, the camera is instructed to read out the CCD as if it were very tiny. The extra pixels of the larger CCD are ignored. This technique requires that the region outside of the ROI be masked, preventing light from contaminating the rest of the CCD area. The readout pattern is specified so that an integral number of images and spacers are fitted along the depth of the CCD beneath the frame transfer mask. While the camera executes a readout pattern that specifies a very small CCD format, the actual image data is streaming down the length of the storage region of the CCD in a pattern of image and spacer blocks determined by the CCD geometry.

In one preferred embodiment of the present invention, the ROI is positioned adjacent to the frame storage mask in the imaging region to provide a well-defined optical edge and to minimize shifting overhead. After a defined exposure period, the ROI is shifted under the frame storage mask. The number of shifts performed to place the ROI under the mask are equal to or greater than the number of rows in the ROI to ensure that ROI is completely under the mask since there are often extra rows between the edge of the frame transfer mask and the beginning of the storage region. Once the ROI is under the mask in the storage region, the next exposure may begin, and so too does the image readout. Now the CCD shifts exactly the number of rows in the ROI into the serial register one at a time and digitizes the number of pixels in each row. In order for this to happen, a valid ROI must be exactly aligned with the bottom of the storage region on the CCD adjacent to the serial register. After one frame readout, everything under the storage mask is moved downward by the size of an ROI. Now the next frame is shifted under the frame storage mask, moving all preceding ROIs downward by the size of one spacer region and the readout cycle is repeated.

This process results in a series of valid ROIs separated by a series of spacer regions aligned down the storage region of the CCD. The spacer regions are a result of the readout of the storage region while the active region is being held constant for exposure (the row shifting clocks are not activated in the active region while the row shifting clocks are activated in the storage region, resulting in a separation of adjacent ROIs by a spacer block). The sum of the spacers plus the valid ROIs should equal the number of rows under the frame storage mask exactly to avoid splitting the image. The stream of images is referred to as a pipeline of images going down the storage region of the CCD. For smaller ROIs, the number of images in the pipeline increases. This method requires a frame transfer type CCD architecture so that exposure and readout cycles can be overlapped and the selective illumination of the ROI only, typically using an optical mask of some sort. As an example, using a standard frame transfer mode of operation, a commercially available frame transfer camera (IPentaMAX) can achieve 83 FPS on a 50×50 ROI. In accordance with this invention, a 50×50 ROI can be read out at 877 FPS

### BRIEF DESCRIPTION OF THE DRAWING

The foregoing and other objects and features of the present invention may become more apparent from a reading of the ensuing detailed description together with the drawing in which:

FIGS. 1 through 4 show a prior art method attempting to read an ROI comprising a small percentage of the pixels in the imaging area of the CCD;

FIG. 5 shows the masking of all but the ROI in the imaging area of the CCD which is advantageously accomplished in the conjugate image plane of the CCD microscope camera of FIG. 6, as shown in FIG. 7;

FIG. 8 shows the improved method of reading out an ROI by the use of the programmed counter; and

FIG. 9 shows details of the timing pulses for reading out the ROI and adjoining areas of the CCD.

### DETAILED DESCRIPTION

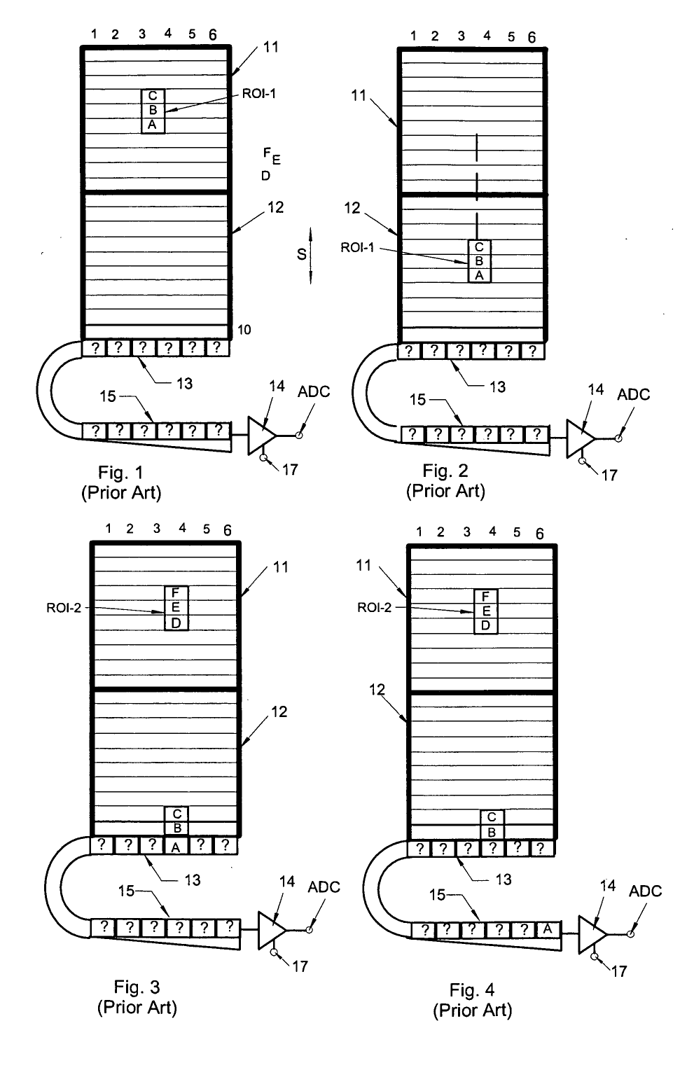

Referring now to FIG. 1, as mentioned above, a conventional frame transfer CCD has an upper portion 11 that can be exposed to light from an object and a lower or storage portion 12 that is shielded from light. After a suitable exposure time is completed, the charges accumulating on the rows of polysilicon pixels in upper portion 11 are shifted down the parallel columns 1-6 into the shielded storage area 12, as shown in FIG. 2. Let it be assumed that all one is interested in is the region of interest ROI-1 comprising pixel rows A, B, C. Nevertheless, each row of pixels ahead of rows A, B, C must be shifted down the length of storage region 12 before the pixels of the next row can be entered into register 13. The same applies to row A of the region of interest which, as shown in FIGS. 3 and 4 must also be shifted along the entire length of serial output register 13 before the pixels of row B can be entered.

Once all of the rows of the image region ROI-1 have been shifted into storage portion 12, as shown in FIG. 2, another exposure may be made by the imaging section 11 thereby acquiring ROI-2 having charges D,E,F, as shown in FIG. 3. Additional vertical shifting steps, FIGS. 2 and 3 are then executed to move the rows of ROI-1 into serial register 13. FIG. 3 shows the moment when row “A” of ROI-1 has just entered into serial shift register 13.

For operation where the object may be dimly illuminated, signal amplification is typically provided by charge multiplication before conversion of the pixel's charges into a voltage. Charge multiplication is accomplished by an extended length portion 15 of serial shift register 13 so that more shifts must take place than the number of pixels in a CCD row This further exacerbates the delay in obtaining a digitized output of the CCD image.

Accordingly, as shown in FIG. 4, before row “B” of ROI-1 can be shifted into serial register 13, all of the charges of row “A” have to be shifted through the extended serial register 13, 15 and all pixel charges but those of row “A” must be discarded by dumping, advantageously by suitably counting and energizing terminal 17 of amplifier 14. At the end of the extended serial register 14, 15 amplifier 14 drives an analog to digital converter ADC that converts the analog voltage into a digital value for further processing by the camera electronics (not shown). The analog to digital conversion operation typically takes much longer than the time to shift rows of the CCD and hence is another limiting factor in high speed readout of the CCD. The foregoingly described process is slow and tortuous and precludes the desired rapid readout of an ROI.

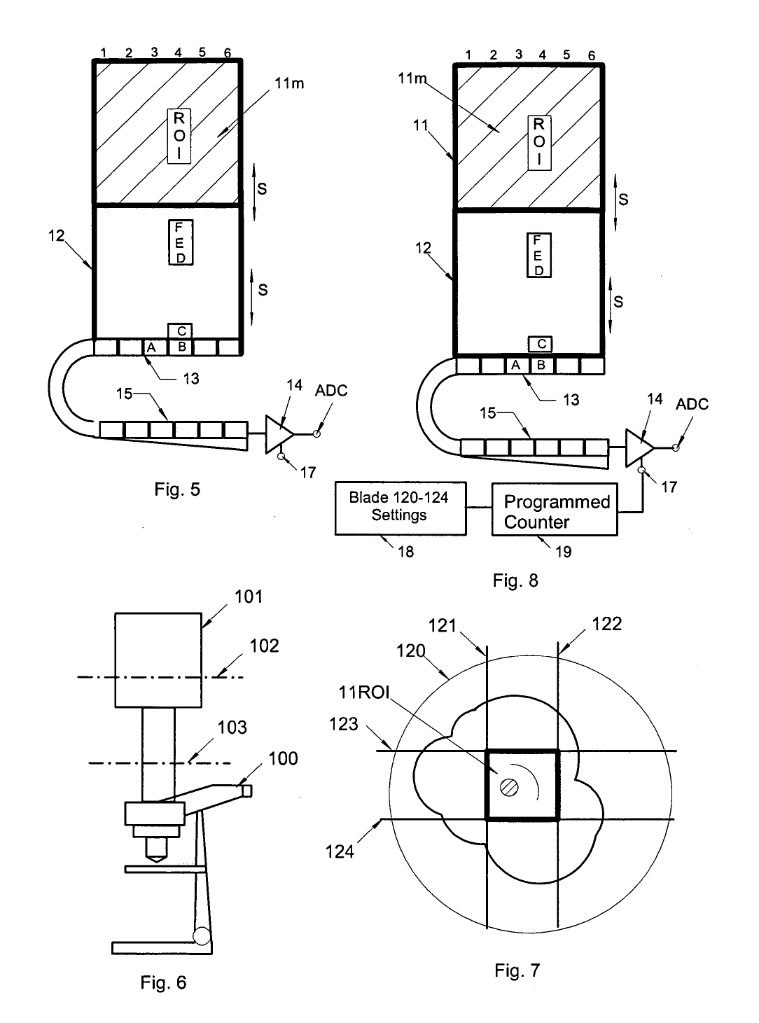

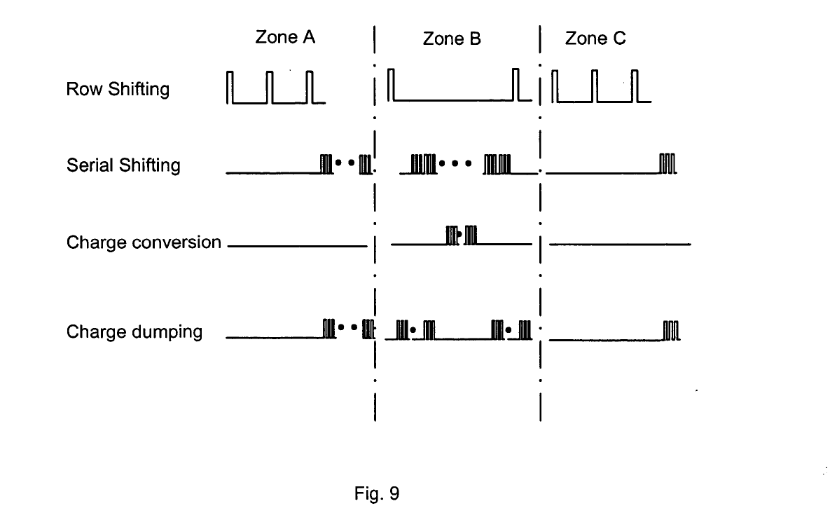

Referring now to FIGS. 5 and 8 there is shown an improved method “pipe-lining” a sequence of images of a region of interest indicated as ROI in the masked imaging portion 11m. In accordance with the principles of FIGS. 5 and 8, each row of the pixels comprising the image of the region of interest are entered into the serial register in immediate sequence to one another without requiring the pixels of one row to be shifted through the entire length of serial output register 13 before the pixels of the next row of the region of interest can be entered into the serial register. In the storage region 12 the pixels constituting the regions of interest are separated from one another by the distance S needed to move the image of the ROI from wherever the ROI is located in masked portion 11m to just under the frame transfer region 12. The first of these images, comprising pixels A, B and C, has already begun to be entered into serial readout register 13, while the next image, comprising pixels DEF is located in the pipeline a distance S behind it. The sum of the number images and the number of spacers will be an odd number since the method produces alternating images and spacers. The net sum of all the image rows and all the spacer rows must equal an integer value, which is the (vertical) size of storage region 12 under the frame transfer mask. This ensures that the first lines of the images will always be aligned with the end of the storage region.

The rules are summarized as follows (note that all values are integers):
T=total storage region row count
Y=ROI row count
S=spacer region row count
r=remainder
n=1, 2, 3, . . .
T=(n+1)*S+n*Y+r, Where S>Y; Select S, Y such that r=0

The scheme described above should work for standard frame transfer type cameras. The extended portion 15 of serial register 13 presents an additional delay that will prevent very high speed imaging. In order to bypass this limitation in speed, a pipeline in both the storage region of the CCD and in the serial register must be created for optimal performance. The present invention therefore extends the high speed ROI readout to use with frame transfer cameras using an extended length, charge amplifying register 15 prior to digitization.

The extended serial register 15 is composed of several spacer regions as well as one or more charge multiplication zones. In this case, a second type of pipeline is required within the serial register; otherwise, extra serial shift events must be included in the readout of each line and these shifts result in a net reduction of frame rates. This pipeline is composed of the valid image row pixels from the ROI preceded or followed (or both) by a block of spacer pixels repeated along the length of the register. These spacer pixels are provided to ensure that the valid pixels do not end up spanning the junction between a charge multiplying zone and a spacer region on the extended serial register. This is done to prevent artifacts in the data which may arise when charge is moved through charge multiplying pixels at varying speeds. If no artifacts are seen, the spacer pixel count can be minimized or possibly eliminated.

Programmed counter 19, FIG. 8, executes the following steps in achieving high speed readout of an ROI:

a. verify the valid row sizes that can be pipelined down the CCD

b. select a desired number of valid pixels per row of ROI;

c. determine the number of spacer pixels required either before or after these valid pixels based on the length of the extended serial register;

d. determine an integer multiple of rows that can fit into the serial register noting that the origin of the ROI can be adjusted along the axis of the serial register in order to achieve an integer value;

e. create a simple readout pattern

f. begin exposure of first image;

g. end exposure of first image;

h. shift whole ROI into storage region past the edge of the frame transfer mask (by the number of rows in the spacer region S);

i. begin exposure of second image;

j. shift one row from the storage region into serial register;

k. skip any pre-pixels adjacent to the ROI;

l. digitize valid pixels of the ROI;

m. skip any post-pixels adjacent to the ROI;

n. repeat until all rows of the ROI are completed;

o. end exposure of second image;

p. shift next image under mask (by the number of spacer rows);

q. begin Readout of ROI 2; and

r. continue as above.

Note that the fastest readout times will be achieved when the programmed exposure time becomes zero, since the time between frame shifts under the mask will then only be limited by the readout time and the frame shift time.

The result data stream from this operation will contain several frames of non-valid images derived from reading out the area under the storage mask prior to a valid ROI reaching the serial register. These non-valid images are discarded by the software since the number of invalid images can be calculated by the image pipeline depth on the CCD and the number of cycles of readout needed to clear this invalid data.

Depending on the exact serial register dimensions, the output of the ROIs may be out of phase with the digitization cycles; that is, the beginning of the images may occur within the middle of a particular frame but this can be resolved easily in software since the images will be output back to back. The simplest manner to resolve the data would be to adjust the beginning point of each frame to the appropriate pixel as calculated from the readout pattern.

The application of this simple method can result in a cameras with very low light sensitivity running at continuous frame rates approaching 5-10 kHz for small ROIs depending on the CCD size and the speed at which the ADC operates and the speed at which the vertical shifting along the CCD is performed. This is an unparalleled performance level that is only possible using our virtual chip method in combination with OCG cameras.

What has been described is deemed to be illustrative of the principles of the invention, Further and other embodiments will be apparent to those skilled in the art and may be made without, however, departing from the spirit and scope of the invention.

1. A method for the high speed reading of a region of interest comprising less than all of the pixels of a CCD camera having an image sensor portion, a frame transfer portion, and a serial output register comprising the steps of:
(a) masking all image sensing pixels of said CCD except the pixels constituting the desired region of interest;
(b) exposing said non-masked portion of said region of interest to an illuminated object to accumulate a charge on each pixel of said region of interest;
(c) rapidly vertically shifting and discarding charges on the rows of pixels between said region of interest and said frame transfer portion;
(d) vertically shifting the rows of pixel charges constituting said region of interest into said serial register;
(e) rapidly vertically shifting and discarding charges on the rows of pixels following said region of interest; and
(f) converting said charges constituting the region of interest into digital values at the output of said serial register.

2. A method for the high speed reading of a region of interest comprising less than all of the pixels of a CCD camera having an image sensor portion, a frame transfer storage portion, and a serial output register comprising the steps of:
a. sequentially exposing only the sensing pixels comprising a region of interest to an illuminated object to accumulate a charge on each pixel of said region of interest;
b. rapidly shifting the charges accumulated on said sequential exposings into said frame transfer storage portion;
c. discarding charges from rows of pixels between said region of interest and said frame transfer storage portion; and
d. pipelining said charges from said frame transfer storage portion into said serial output register.

3. A method for the high speed reading of a region of interest according to claim 2 wherein each said sequential exposure is begun when a previous exposure has been entered into said frame transfer portion.

4. A method for the high speed reading of a region of interest according to claim 3 wherein pixels entered into said serial register prior to the pixels of said region of interest are discarded before digitizing pixels of said region of interest.

5. A method for the high speed reading of a region of interest according to claim 3 wherein pixels entered into said serial register subsequently to the pixels of said region of interest are discarded after digitizing pixels of said region of interest.

6. A method for the high speed reading of a region of interest according to claim 3 wherein a next sequential image of said region of interest is shifted into said frame transfer portion after said subsequently entered pixels are discarded.

7. A method for the high speed reading according to claim 2 wherein light is restricted to said area of interest by a conjugate optical plane mask.

8. A method for the high speed reading according to claim 7 including an optical microscope and wherein said mask is located in the conjugate optical plane of said microscope.

9. A method for the high speed reading according to claim 8 including a programmed counter and wherein the location of said mask is entered into said counter to control said shifting and said pipelining of said charges.
